(19) United States
(12) Patent Application Publication
(10) Pub. No.: US 2013/0132910 A1
(43) Pub. Date: May 23, 2013

(54) BELT ADAPTED TO MOVEMENTS IN VIRTUAL REALITY

(71) Applicant: Eric Belmon, Elancourt (FR)

(72) Inventor: Eric Belmon, Elancourt (FR)

(73) Assignee: AMPLISENS, Voisins le Bretonneux (FR)

(21) Appl. No.: 13/642,194

(22) PCT Filed: Apr. 20, 2010
(86) PCT No.: PCT/FR10/50754

§ 371 Date: Dec. 19, 2012

(30) Foreign Application Priority Data
Apr. 21, 2009 (FR) 0901912

(51) Int. Cl. G06F 3/0481

(52) U.S. Cl. CPC G06F 3/04815
USPC 715/850

(57) ABSTRACT

Disclosed is a device (1) for moving in virtual reality including a substantially rigid node (4) and an envelope (5) arranged so as to be capable of movement in all directions about the node (4), the envelope (5) defining with the node (4) a surface for the movement of a person (2), and the assembly defined by the node and the envelope bearing on an appropriate bearing element (6). The envelope can be mounted so as to slide against the node, or at least a portion of the node.

The present invention relates to a device adapted for moving in virtual reality, without the risk of encountering an obstacle in physical reality.

When a person wears a virtual reality helmet, that person can no longer see the physical reality in which he is located. Furthermore, the movements offered to him in the virtual reality are not always compatible with the configuration and dimensions of that physical location.

The prior art provides several complex solutions that tend to keep the person in a limited physical space by making him move on a device that offsets, in real space, the movements he makes in virtual space.

A first among these devices comprises several transverse conveyor belts driven longitudinally in an endless loop. The loop makes it possible to move the belts forward or backward in the loop, and each belt can move to the right or left of the loop, independently, under the person's steps and in the direction opposite the direction of movement of that person in virtual reality. Thus, in physical reality, the person remains substantially in the same place, in the middle of the device. Such a device is particularly bulky and complex and in particular unsuitable for recreational use.

A second of these devices comprises several plates moving on the ground of the real place, coming in front of the person's steps and bringing it back in the direction opposite his movements. Thus, in physical reality, the person moves in a restricted and controlled space. Such a device is less bulky than the first. It is, however, difficult to implement. It is also not very responsive, in particular in case of rapid movements by the person in the virtual reality.

The aim of the invention is to propose a device for a person's movement in virtual reality that allows that person to move in a restricted space of physical reality, is easy to manufacture and implement, and can be adapted to a recreational use.

To achieve that aim, the invention proposes a device characterized in that it comprises a substantially rigid node and an envelope arranged to be able to move in all directions around the node, the envelope forming a surface with the node for the movement of a person, the assembly formed by the node and its envelope resting on suitable support means. The envelope can be slidingly mounted against the node, against at least part of the node.

Means are advantageously provided to keep the node substantially immobile in the space. These means for keeping the node immobile can comprise lateral stop means with balls or mutual interlocking means, for example a convex shape that engages with a complementary concave shape in the node, preferably a convex shape of the support means.

Advantageously, the device may comprise a matrix of balls in contact with the envelope. The balls are advantageously motorized so that they participate in moving the envelope around the node. The matrix can be comprised in the support means or in the node. In particular when the node comprises motorized balls, the device advantageously comprises induction power of the node, in particular for the motorization of the balls.

A device according to the invention advantageously comprises means for subjugating a movement of the envelope to a movement of a user in virtual reality.

The movement surface is preferably substantially flat. The envelope is preferably such that it would be able to assume a sphere shape if it was stretched uniformly. The support means advantageously comprise means for tilting the movement surface.

The upper surface of the node can comprise pressure sensors, which are preferably uniformly distributed, in particular to know the position of the feet of the person using the device.

The envelope can be substantially translucent or transparent and the upper surface of the node comprises a light display for a display intended for the person using the device.

Several embodiments of the invention will be described below, as non-limiting examples, in reference to the appended drawings, in which:

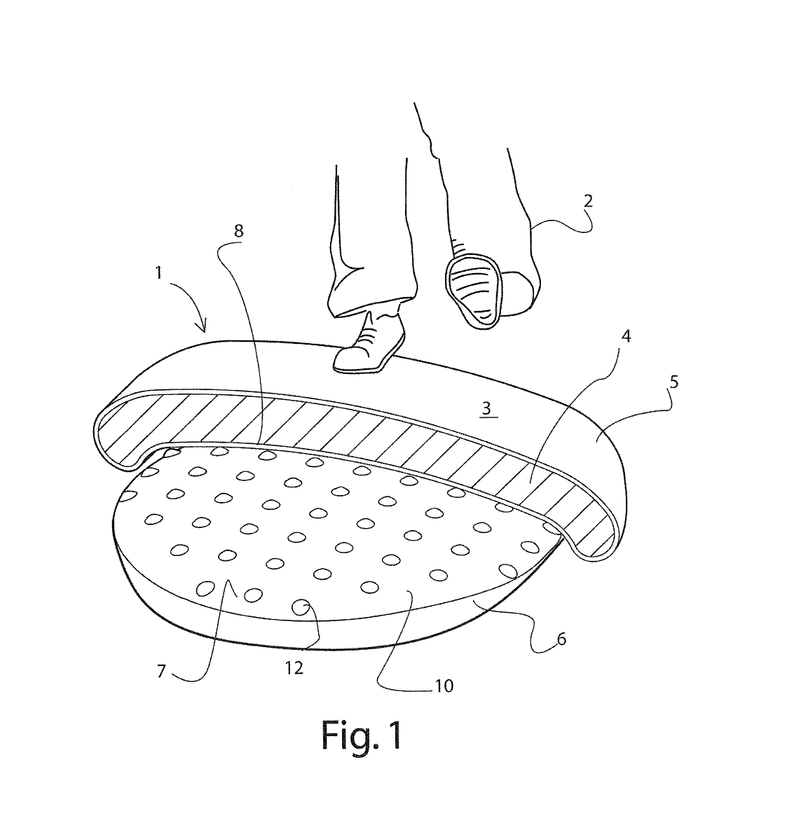

FIG. 1 illustrates a first embodiment of a device according to the invention;

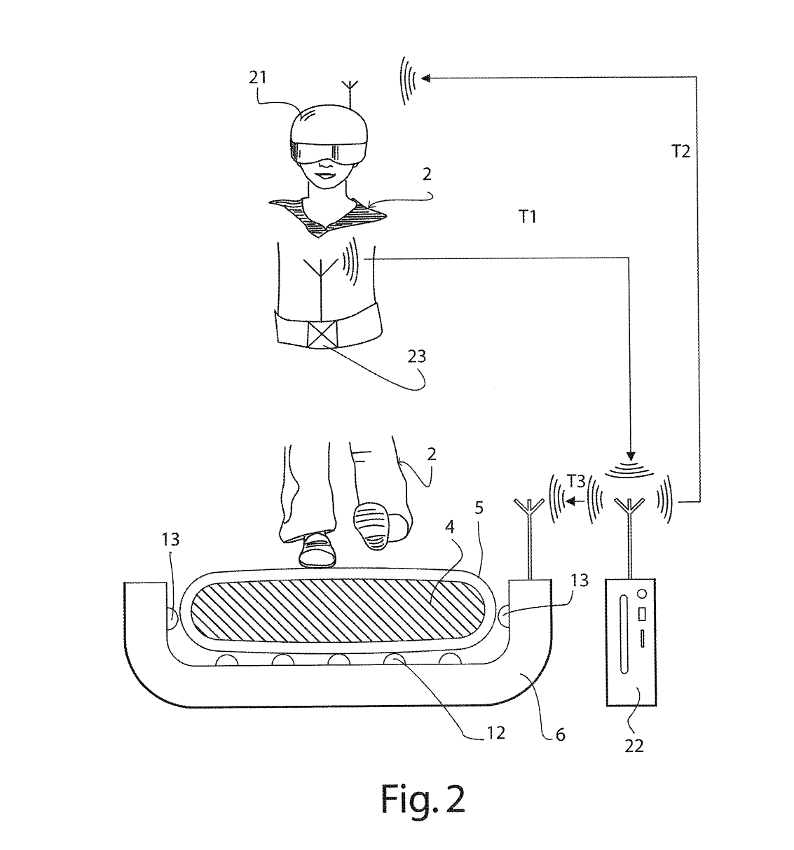

FIG. 2 illustrates a second embodiment of a device according to the invention;

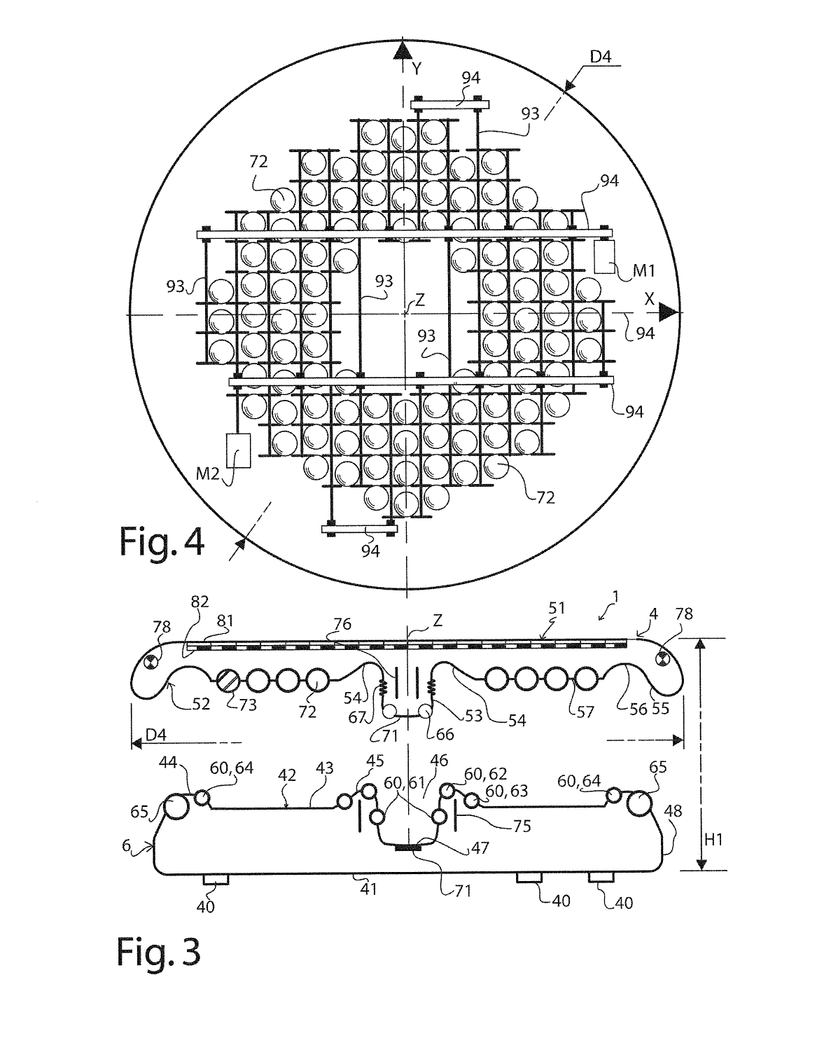

FIG. 3 is an axial diagrammatic cross-section of a third, preferred embodiment of a device according to the invention;

FIG. 4 illustrates a diagrammatic planar view of the means for driving the belt, in the embodiment of FIG. 3;

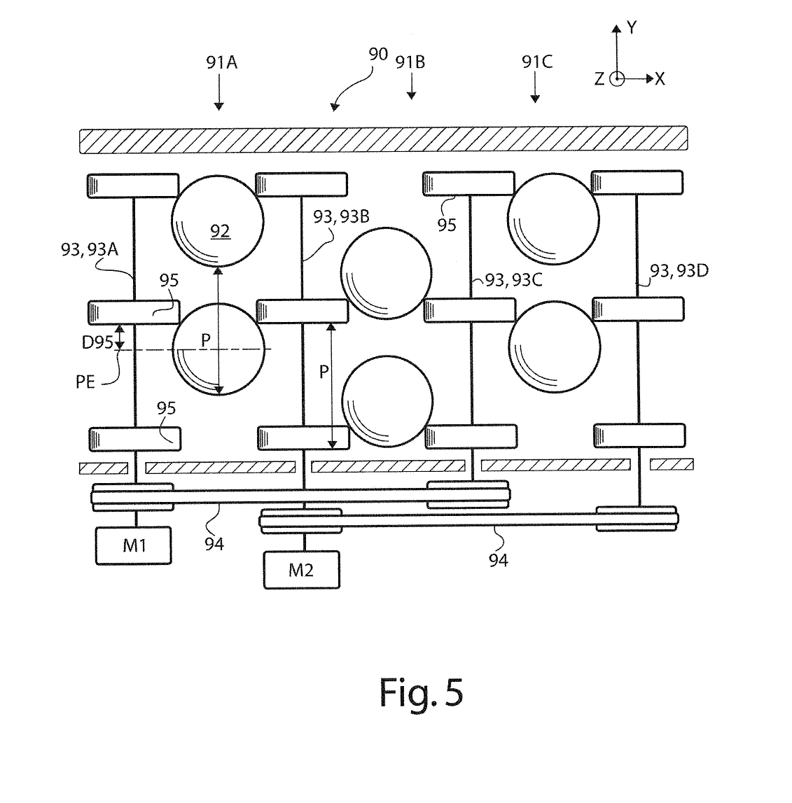

FIG. 5 illustrates the principle of a driving mode used in particular in the embodiment of FIGS. 3 and 4, and particularly illustrated in FIG. 4; and

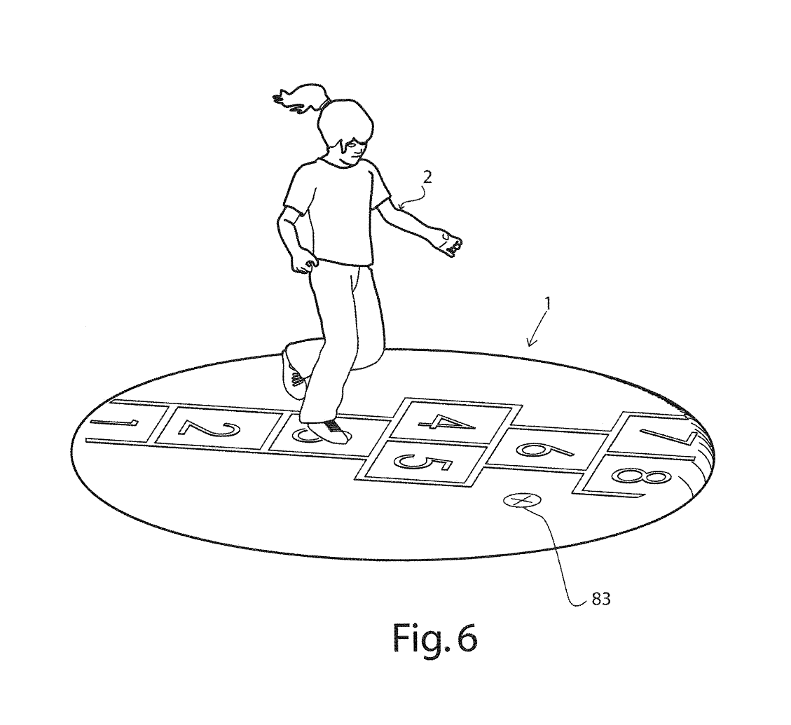

FIG. 6 illustrates a use of the device of FIGS. 3 and 4.

FIGS. 1 to 3 each illustrate a device 1 adapted to the movement of a user 2 in virtual reality. Each device forms a multi-directional belt 4, 5, i.e. which offers a movement surface 3 that allows the user to move in all directions, parallel to that surface 3. In the illustrated examples, the movement surface 3 is substantially flat and horizontal.

The movement surface 3 is formed by associating a node 4 and an envelope 5. In FIGS. 1 to 3, the node is shown in cross-section. The node 4 is substantially rigid, and can be made from a solid or hollow material.

The envelope is mounted slidingly mobile around the node. It is made from a flexible and slightly or not at all elastic material. It has a shape such that it is substantially identical at all points, i.e. substantially isotropic, in each of the directions of the envelope from that point. Thus, the envelope is preferably provided so that it would substantially assume a sphere shape if one were to apply uniform pressure inside said envelope, with the exception of any other forces. The envelope can be formed like a tennis ball, by the assembly and sewing of two identical and complementary elements.

The assembly formed by the envelope around the node rests on support means 6 formed by a base 6. The base 6 is substantially rigid, and it is provided to rest on the floor of a location of the physical reality.

The assembly made up of the base 6 and the belt 4, 5 substantially has a shape of revolution around a vertical axis.

In the example illustrated in FIG. 1, the base 6 has a generally convex upper shape 7 complementary to a concave shape 8 of the node. Thus, the node 4 has a substantially bean-shaped axial cross-section, as illustrated in FIG. 1. The belt 4, 5 simply rests on the base 6, by fitting its concave shape 8 on the complementary convex shape 7 of the base 6.

An upper area 10 of the base 6 supports balls 12. This area 10 substantially occupies the convex shape 7 on which the belt 4, 5 rests. Each of the balls 12 is rotatably mounted around a respective point stationary relative to the base 6. Each ball is mounted so that it can perform, substantially without friction, any rotation around its respective fixed point. The balls 12 are regularly distributed over the area 10 of the base 6. The belt 4, 5 is provided to rest only on the balls 12, by contact of the balls on the outer surface of the envelope 5.

Due to the complementary shapes 7, 8 of the base 6 and the node 4, the node 4 is kept substantially immobile relative to the base 6.

The contact between the envelope 5 and its node is provided so that when a person 2 moves on the surface 3, the friction exerted by the person on the envelope and the friction exerted by the assembly of the balls in the location of their contact with the envelope are each clearly greater than the friction of the envelope on its node. Preferably, a lubricant is used between the envelope and the node to limit the friction exerted there. The arrangement of the envelope 5, all around the node, particular to the invention, makes it possible to ensure good sealing, so that the lubricant remains confined. Furthermore, the circulation of the envelope around the node allows good distribution of the lubricant and the recovery of the lubricant that will be driven downward by gravity.

The envelope is preferably chosen in a very slightly or not at all elastic material, so that the contact with the person 2, or the balls 12, does not cause any local deformation of the envelope. The envelope can, for example be a cloth.

Preferably, the balls 12 are motorized and their rotation is preferably subjugated to the movement of the person in virtual reality. Thus, when the person moves by one step in virtual reality, the envelope, in the location of the movement surface 3, moves substantially the same distance in an opposite direction. As a result, in physical reality, the person is constantly returned to or kept in the movement surface 3, in a position that offers him several steps in a direction that may be determined by the device statistically based on the instantaneous movement of the person and the instantaneous orientation of his head. Such a position is generally situated close to an edge of the device 1, so that the largest possible field of movement extends in front of the person. Thus, the belt can move gradually under the person's steps, allowing him to first advance slightly in his direction of movement, which makes it possible to have a very gradual acceleration of the belt, felt little or not at all by the user.

The subjugation can be calculated from a detection of the forces exerted by the person on the belt, when he moves.

The subjugation can also be calculated from measurements by a gyroscopic sensor worn on the body of the person 2, as will be described in reference to FIG. 2.

Thus, irrespective of the distance that the person 2 travels in virtual reality, he remains confined in a restricted space of physical reality, space that is defined by the movement surface 3, without leaving the belt 4, 5.

We will now describe the embodiment of FIG. 2 inasmuch as it differs from the embodiment previously described. In the embodiment of FIG. 2, the node 4 has a substantially oblong axial cross-section and the base 6 is bowl-shaped. The belt 4, 5 is housed in the bowl formed by the base.

Support balls 12 are arranged at the bottom of the bowl. Other balls 13, forming lateral stops, are arranged on the inner periphery of the base 6 in order to keep the belt 4, 5 substantially without friction, immobile inside the base 6. The stop balls 13 can be mounted loose, or motorized and subjugated so that they participate with the support balls in moving the envelope 4.

In the example of FIG. 2, the device also comprises a helmet 21 for displaying the virtual reality before the eyes of the person 2 using the device, a console 22 for generating the virtual reality, and a belt bearing the gyroscopic sensor 23.

The data collected by the sensor 23 is transmitted to the console 22, as illustrated in the figure by arrow T1. From that data, the console 22 calculates in real-time the images that must be displayed by the helmet 21 and sends it the necessary information, as illustrated in the figure by arrow T2. Likewise, and substantially simultaneously, the console 22 calculates, in real-time, the movements that the envelope must make around the node and transmits, along T2, the information needed for the corresponding subjugation of the balls 12, 13. In this configuration, the movement of the person in virtual reality is taken into account, even if he is not in constant contact with the belt, for example during running or jumping.

FIGS. 3 and 4 describe a device 1 according to a third, preferred embodiment of the invention. We will first describe the node 4 and base 6 thereof, in reference to FIG. 3. For better readability, the envelope 5 is not shown in FIGS. 3 and 4. Furthermore, in FIG. 3, the base and the node are shown vertically spaced apart from each other. Nevertheless, in this third embodiment, as in those previously described, the envelope is provided to surround the node and to be pinched, in the lower portion thereof, between the node and the base, the belt formed by the node and its envelope resting on the base.

The base 6 substantially has a shape of revolution around a vertical axis Z. It comprises a substantially flat lower surface 41 that rests on three feet 40 regularly distributed near the periphery of said lower surface 41. The base 6 also comprises an upper surface 42 with a complex shape. The surface 42 comprises an annular, substantially planar depression 43. The depression 43 is limited on the outside by an annular outer embankment 44 and on the inside by an annular inner embankment 45. The upper surface 42 also comprises a central well 46, upwardly open and outwardly delimited, in its upper portion, by the inner embankment 45. In the illustrated example, the well is downwardly closed by a bottom 47, the level of which is lower than that of the depression 43. The outer edges of the lower surface 41 and the upper surface 42 of the base 6 are connected to each other by a substantially cylindrical portion 48.

In this third embodiment, the node 6 is hollow. It comprises a substantially planar and horizontal upper surface 51. It also comprises a lower surface 52 with a complex shape complementary to that of the upper surface 42 of the base 6. The lower surface 52 of the node comprises an appendage 53 provided to be vertically inserted into the well 46. The appendage 53 is surrounded by an annular inner groove 54, complementary to the inner embankment 45. The lower surface 52 also forms a skirt 55 provided to extend around the base 6 along its cylindrical portion 48. The skirt 55 is inwardly limited by an annular outer groove 56 complementary to the outer embankment 44. The grooves 54, 56 delimit a substantially horizontal annular plate 57 between them, complementary to the bowl 43.

The shape of the node, and the complementary shape of the base, is provided to absorb at least part of the deformations of the envelope 5, designed as a sphere but used in a flattened form, at least in the user movement area, on the upper surface 51 of the node.

The base 6 comprises balls 60 arranged in four horizontal crowns 61-64. Each ball 60 is mounted loose through the upper surface 42 of the base 6, in a respective housing. A first crown 61 of balls 60 is arranged substantially at mid-height of the well 46, and in particular makes it possible to maintain the envelope 5, stretched, away from the walls of the well 46. A second crown 62 of balls 60 is arranged at the apex of the inner embankment 45, and a third crown 63 of balls 60 is arranged substantially at the junction of the inner embankment 45 and the depression 43. The crowns 61, 62, 63 in particular cooperate to keep the envelope 5, stretched, away from the walls of the inner embankment 45. A fourth crown 64 of balls 60 is arranged at the apex of the outer embankment 44, along its edge overhanging the depression 43.

The device 1 is provided so that the crown of balls 65 serves as a support for the belt on the base, i.e. so that only that crown reacts the loads of the belt 4, 5 and so that it bears in particular the weight of the person using the device.

The base also comprises another crown of balls 65, arranged at the apex of the outer embankment 44, along its edge opposite the skirt 55. The node and the base also comprise an angular sensor 71, one part of which is positioned at the bottom 47 of the well 46 and the other part of which is positioned opposite the first, at the end of the appendage 53. The angular sensor is provided to determine the relative angular position of the base 6 and the node 4. At least one of the balls 65 is motorized, so that it can angularly position, around the vertical axis Z, the node relative to the base. It also makes it possible to substantially maintain the belt 4, 5 in a given angular position relative to the base 6. The belt is provided to be able to turn freely around its axis over 360°. The device 1 is provided so that the crown of balls 65 serves as a support for the base, i.e. so that only the crown reacts the loads of the belt 4, 5 and in that it in particular bears the weight of the person using the device.

The base comprises a crown of balls arranged on the periphery of the end of the appendage 53, so that they prevent the friction of the envelope 5 against the appendage 53.

The appendage 53 also comprises vertical extension means 67, diagrammed by bellows in FIG. 3. The vertical extension means 67 make it possible to keep the envelope 5 stretched, in particular to offer a flat and regularly moved surface, at the user's feet. This also makes it possible to compensate an expansion of the envelope, for example due to its heating during use, or to offset deformations, for example related to the aging of the envelope. The well 46 is therefore provided to allow the free extension of the appendage 53 there, within the limits set.

The plate 57 bears a matrix of driving balls 72, more particularly illustrated in FIG. 4. The balls are mounted in the plate, each in a respective housing so that they can rotate along any axis relative to said housing, while being kept translationally immobile relative to said housing. The driving balls 72 are provided to have the same movement simultaneously relative to their respective housing. They are driven by two unique motors M1 and M2, according to a principle that will be described in reference to FIG. 5.

In FIG. 4, all of the balls 72 supported by the plate 57 are provided to be motorized. However, one 73, illustrated cross-hatched in FIG. 3, or several of them can be provided mounted loose in its respective housing, so that it is moved only by its contact with the moving envelope. The ball 73 does not transmit any force. Thus, through sensing means, it is possible to compare its instantaneous speed and axis of rotation and compare them to those of a driving ball 72. The difference will be a skid corresponding to sliding of the balls 72 on the envelope. The device 1 is provided to correct the movement of the envelope to offset that skid.

In the illustrated example, the electrical power supply for the belt is done without contact, by inductive means 75, 76. The inductive means 75, 76 comprise a first coil 75 positioned in the base around the well 46 and a second coil 76, arranged in the appendage 53, so that they are coaxial.

Sensors 78, for example magnetic sensors, are advantageously provided at the periphery of the base, to cooperate with a helmet worn by the user, in order to determine the position of the user's head, and the movements of his head, relative to the belt.

The upper surface of the node 4 comprises pressure sensors 81, regularly distributed on its surface. They are illustrated in FIG. 3 by an alignment of white rectangles. They make it possible to determine the position of the user's feet, measure pressure variations, and for example contribute to anticipating a movement or a jump.

The upper surface of the node 4 also comprises luminous elements, forming pixels, illustrated in FIG. 3 by an alignment of alternating white and black rectangles. The pixels together form a screen and allow a light display. The envelope is advantageously provided to be translucent or transparent so that the display is visible through the envelope.

In an immersive usage mode, i.e. the virtual reality is for example projected on the walls of a room where the device 1 is located, the display can be adapted to reproduce the floor of the virtual reality location. The display 82, combined with the pressure sensors 81, can constitute a touchscreen, which can be used to control the device with the foot, for example by displaying commands such as start, pause or stop.

As particularly illustrated in FIG. 6, the display 82 can represent a game, such as a hopscotch. When the X 83 is touched with the foot, it makes it possible to stop the operation of the device. The X can be moved on the display, so that it always stays accessible, although the device 1 tends always to bring the user 2 back toward an optimal position, which leaves a greater possibility of movement in front of him.

In one preferred embodiment, the display is done using light-emitting diodes (LED).

The skirt 55 makes it possible to limit the possibility of objects becoming inserted between the base 6 and the belt 4, 5. In particular, the skirt limits the introduction of dust or small objects that can disrupt the operation of the device 1.

The feet 40 comprise pressure sensors. The information provided by those sensors can be used in several ways. First, the sum of the pressures must remain substantially constant. A pressure variation beyond a given value is interpreted as the appearance of a second person on the belt, which is potentially dangerous, and causes the automatic and immediate stop of the device 1. Secondly, they make it possible to determine, by triangulation, the position and movement of the belt user's center of gravity, and to drive the movement of the envelope accordingly. Thirdly, they serve to determine the force to be supplied to move the envelope.

The height of the feet can be adjusted, so that it is possible to offset certain irregularities of the ground on which the device rests. Furthermore, the feet can comprise jack means, so that the device can be tilted, to simulate a slope for the user. The jack means can be provided, for example, to simulate a slope that can vary from 0% to 6%.

Although the two previously described embodiments are relatively simple to manufacture, the position of the balls 12 predisposes them to dirtying, in particular by gravitational accumulation of dust in the housing of each connecting rod, or by the driving of dust at the surface of the balls. In the third embodiment, driving balls 72 are supported by the node 4 and positioned below the node. Thus, the envelope 5 (not shown in FIGS. 3 and 4) being provided to surround the node, the balls are protected from outside dust by the envelope. Furthermore, the housings of the balls are oriented downwardly, so that no dust or small objects can penetrate them by gravity.

Furthermore, the enclosure of the driving balls and their motorization makes it possible to limit the noise they emit. In fact, that noise, in particular during accelerations, is an indicator that connects the user to the real world and can disrupt his vision of the virtual world, and in particular can disrupt his balance.

In this third preferred embodiment of the invention, the device as illustrated has the following characteristics:

outer diameter D4 of the belt: 1 m80

thickness H1 of the device: 16 cm

number of driving balls 72: about 300 balls

diameter of each driving ball: 30 to 40 mm, preferably 35 mm.

The large number of balls and their small diameter allows better distribution of forces.

Of course, these dimensions are not limiting.

It may be advantageous for the device to be incorporated into a floor, so that it does not have a level difference with the floor. For example, the device can be positioned at the bottom of a pit, or inside a false floor.

We will now describe the operation of the motorization of the balls 12, 72 in reference to an example of a simplified motorization 90 illustrated in FIG. 5. Three columns 91A, 91B, 91C of two balls 92, representative of the balls 12 or 72 of the examples above, are shown there. The columns are parallel to an axis Y. Each column 91 is positioned between two shafts 93, 93A-93D parallel to each other and the axis Y. Each ball is mounted to be able to perform any rotation around a respective point kept stationary. The balls of a same column are spaced by a pitch P along the axis Y. An axis X, perpendicular to the axis Y, defines, with the axis Y, a plane passing through the center of the balls and comprising the axes of the shafts 93. An axis Z is defined perpendicular to the plane X, Y.

The motorization comprises two motors M1, M2. A first shaft 93A is directly engaged with the motor M1, and a second shaft 93B is directly engaged with the motor M2. A third shaft 93C is indirectly driven by the motor M1, owing to a return by pulley and belt 94. The fourth shaft 93D is indirectly driven by the motor M2, owing to another return by pulley and belt 94. Each shaft 93 supports three disks 95 with identical dimensions, coaxial to the shaft 93 and separate from each other, along the axis Y, by the same pitch P as the balls.

The balls and the disks are positioned so that each ball is in slip-free contact with a respective disk of each of the shafts between which it is located. For each ball 92, the contact is offset by a distance D95 on either side of an equatorial plane PE, perpendicular to the axis Y. The distance D95 is identical irrespective of the ball 92. For the balls of the first and third columns 91A, 91C, the offset is positive, i.e. along the direction of the axis Y. On the contrary, for the balls in the second column, the offset is negative, i.e. in the direction opposite the axis Y. Thus, for a larger number of columns, there is alternatively a positive, then negative offset.

The motors M1 and M2 are controlled in speed and direction of rotation, in order to drive the balls, all simultaneously identically. When the two motors rotate in the same direction at the same speed, all of the balls 92 rotate together in the same direction around a respective axis parallel to the axis X. When the two motors turn at the same speed, but in opposite directions, the balls 92 rotate together in the same direction around a respective axis parallel to the axis X. Thus, depending on the speeds and directions of rotation of the motors, it is possible to rotate the balls together in the same direction around a selected respective axis, of plane X, Y.

Of course, the invention is not limited to the examples just described.

The means described in particular in reference to the third embodiment are not specific to it, inasmuch as they are compatible with one considered embodiment. Thus, it is possible to provide in one embodiment, for example the first or second, means for tilting the base so that the movement surface offers the user the feeling of traveling an incline, a decline or a slope.

Opposing magnets or electromagnets can be placed in the base and the node so that they tend to raise the node, and thus limit the pinching of the envelope against the base and the node, in order to limit the forces to be applied to the envelope to move it around the node. They can also be positioned so that they tend to recenter the node relative to the base, thereby offsetting the movements of the belt under the action of the user's feet. These two actions may or may not be combined.

One or more sensors can be positioned between the base and the node in order to detect an actual accidental raising of the node relative to the base, which can be the sign of the introduction of clothing, snagged by the device. The device is then advantageously provided to stop upon that signal, as a security measure.

The base can include the console, which defines the virtual reality. It can also comprise adjustment or configuration means, in particular a storage medium reader, in particular to be able to be associated with one or more types of commercially available console.

The gyroscope means can be incorporated into the helmet rather than a belt. Thus, it is possible to provide, when the user turns his head in a direction, for anticipating a movement by the user in the same direction, and starting the movement of the belt accordingly.

In the third embodiment, the well may not comprise a bottom and be provided downwardly open, i.e. vertically through the base.

In the third embodiment, instead of having an inductive transmission of the energy necessary for the operation of the belt 4, 5, it is possible to provide for conductive transmission. For each pole, for example phase and neutral, it is possible to provide opposite terminals, one supported by the base 6, the other by the belt. It is possible to provide that the envelope includes contact discs passing through its thickness and regularly distributed, so that at any time, irrespective of the position of the envelope around the node, for each pole at least one disc is in contact simultaneously with the two terminals of the pole. Thus, continuous power is provided to the belt by the base.

To prevent objects or dust from being inserted between the base and the belt, it is possible to provide a brush system positioned on the periphery of the base and passing over the surface of the envelope.

A device according to the invention can be associated with a game console. It can also be used in a gymnasium or for muscular rehabilitation, for example walking rehabilitation.

1. A device (1) for moving in virtual reality, characterized in that it comprises a substantially rigid node (4) and an envelope (5) arranged to be able to move in all directions around the node, the envelope forming, with an upper surface (51) of the node, a surface (3) adapted for the movement of a person (2), the assembly formed by the node and its envelope resting on suitable support means (6).

2. The device according to claim 1, characterized in that the envelope is slidingly mounted against the node.

3. The device according to claim 1, characterized in that it comprises means (13; 65, 71) to keep the node substantially immobile in space.

4. The device according to claim 3, characterized in that the means for keeping the node immobile comprise lateral stop means with balls (13, 65).

5. The device according to claim 3, characterized in that the means for keeping the node immobile comprise a convex shape that engages with a complementary concave shape in the node, preferably a convex shape (10; 44) of the support means.

6. The device according to claim 1, characterized in that the device (1) comprises a matrix of balls (12, 72) in contact with the envelope (5).

7. The device according to claim 6, characterized in that the balls (12, 72) of the matrix are motorized.

8. The device according to claim 7, characterized in that the motorized balls (12) are comprised in the support means (6).

9. The device according to claim 7, characterized in that the motorized balls (72) are comprised in the node (4).

10. The device according to claim 9, characterized in that it comprises induction power (75, 76) of the node for the motorization of the balls (72).

11. The device according to claim 1, characterized in that it comprises means for subjugating a movement of the envelope to a movement of a user in virtual reality.

12. The device according to claim 1, characterized in that the movement surface (3) is substantially flat.

13. The device according to claim 1, characterized in that the envelope (5) would be able to assume a sphere shape if it was stretched uniformly.

14. The device according to claim 1, characterized in that the support means comprise means for tilting the movement surface.

15. The device according to claim 1, characterized in that the upper surface (51) of the node (6) comprises pressure sensors (81) which are preferably uniformly distributed.

16. The device according to claim 1, characterized in that the envelope is substantially translucent or transparent, and in that the upper surface (51) of the node (6) comprises a light display (82).

17. The device according to claim 1, characterized in that it comprises means (65) for allowing the belt (4, 5) to rotate freely around its vertical axis (Z).

18. The device according to claim 16, characterized in that the means (65) for allowing the belt to rotate freely around its vertical axis (Z) are motorized means.

19. The device according to claim 2, characterized in that it comprises means (13; 65, 71) to keep the node substantially immobile in space.

20. The device according to claim 4, characterized in that the means for keeping the node immobile comprise a convex shape that engages with a complementary concave shape in the node, preferably a convex shape (10; 44) of the support means.
